(19) United States
(12) Patent Application Publication
(10) Pub. No.: US 2022/0081928 A1
(43) Pub. Date: Mar. 17, 2022

(54) Device for Supporting an Electrified Wire

(71) Applicant: Emile Stassen VAN DER MERWE, Hamilton (NZ)

(72) Inventor: Emile Stassen Van Der Merwe, (US)

(21) Appl. No.: 17/302,130

(22) PCT Filed: Oct. 30, 2019
(86) PCT No.: PCT/NZ2019/050144

§ 371 Date: Apr. 24, 2021

(30) Foreign Application Priority Data
Oct. 31, 2018 (NZ) 747855
Mar. 5, 2019 (NZ) 751263
Jul. 22, 2019 (NZ) 755631

(51) Int. Cl. E04H 17/10; H01B 17/14; E04H 17/00; A01K 3/00

(52) U.S. Cl. CPC E04H 17/10; A01K 3/005; E04H 17/017; H01B 17/145

(57) ABSTRACT

The Device for Supporting an Electrified Wire is a device for supporting an electrified elongate conductor on a fence or other structure, the device comprising: an insulating base for attaching said device to a fence or other structure, a spring connectively attached to said base, and an elongate member connectively attached to said spring positioned to extend away from said fence or other structure, wherein said spring is configured to deform elastically to allow the elongate member to move from an un-deflected position with a distal end laterally away from the fence or other structure to a deflected position towards the fence or other structure in at least a sideways direction upon application of a force lateral to the elongate member, and to spring back again to the un-deflected position once the force is removed. It is used to contain and alter the movement activity of livestock.

### TECHNICAL FIELD

The present invention relates to a device for mounting and supporting a live (electrified) wire on a fence or other structure for the containment and control of livestock.

### BACKGROUND

On farms, outriggers are provided to farms fences and other structures to support an electrified wire laterally outwards from the fence or other structure. The outrigger includes an insulated loop or other retainer to support and hold the wire, so that the wire can hold a voltage. When contacted by an animal, the wire provides the animal with an electric shock, to deter the animal from proceeding to make contact with the fence.

Outriggers are typically stiff, to ensure the wire is held securely outwards from the fence. When a large animal such as a cow contacts an outrigger, the outrigger can be broken or dislodged from the fence, causing the wire to contact the fence or other electrically grounded structure.

This can cause a short circuit to ground, causing an electrical power supply electrifying the wire to fail. To restore the electric barrier provided by the wire and power supply, a farmer or other person must find and rectify the damaged or dislodged outrigger. Locating a broken or dislodged outrigger on a long length of fencing or fences can be time consuming.

It is an object of the present invention to address one or more of the foregoing problems or at least to provide the public with a useful choice.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

Further aspects and advantages of the present invention will become apparent from the ensuing description which is given by way of example only.

### BRIEF DESCRIPTION

According to a first aspect of the present invention there is provided a device for supporting an electrified elongate conductor on a fence or other structure, the device comprising: at least one base for attaching the device to a fence or other structure, at least one spring adjacent the base, and at least one elongate member extending from the spring and away from the fence or other structure in use, the spring and the elongate member integrally formed from a length of wire; wherein the base is formed from or comprises an insulating material, so that the base forms an insulator to insulate the spring and the elongate member from the fence or structure; wherein the spring(s) is/are configured to deform elastically to allow the elongate member to move from an un-deflected position with a distal end laterally away from the fence or other structure to a deflected position towards the fence or other structure in at least a sideways direction upon application of a force lateral to the elongate member, and to spring back again to the un-deflected position once the force is removed.

In some embodiments, the device is an outrigger for holding the conductor away from the fence, wherein the outrigger comprises a holder for supporting the conductor, the elongate member extending between the spring and the holder to space the conductor laterally away from the fence or other structure, wherein the spring(s) is/are configured to deform elastically to allow the elongate member and holder to move from the un-deflected position with the conductor supported laterally away from the fence or other structure to the deflected position towards the fence or other structure in at least a sideways direction upon application of a force lateral to the elongate member or holder, and to spring back again to the un-deflected position once the force is removed.

In some embodiments, the resilient element is a coil spring.

In some embodiments, the elongate member extends longitudinally with respect to a longitudinal axis of the coil spring.

In some embodiments, the wire is a high tensile fencing wire.

In some embodiments, the base is integrally formed with the spring.

In some embodiments, the device comprises an insulation material covering the holder and the elongate member for substantially a full length of the elongate member.

In some embodiments, the holder and the elongate member are integrally formed from the length of wire, and wherein the holder is a loop of the wire.

In some embodiments, the spring is assembled to the base in use.

In some embodiments, in use the spring and the elongate member are electrified by the elongate conductor.

In some embodiments, the base comprises a substantially cylindrical portion and the spring is a coil spring, and the spring is received on the cylindrical portion to attach the spring to the base.

In some embodiments, the insulating base is adapted to hold the electrified elongate conductor.

In some embodiments, the insulating base holds the electrified elongate conductor in electrical contact with the spring and/or the elongate member to electrify the spring and/or the elongate member in use.

The device comprises an insulator (the base), to insulate/isolate the device from the fence or other structure.

In some embodiments, the device comprises: a first spring and a second spring, the at least one elongate member extending between the first and second springs and the holder, and wherein the outrigger is adapted to be attached to the fence or other structure with the first and second springs spaced vertically apart to resist deflection of the elongate member and holder in a vertical direction.

In some embodiments, the device comprises: a first base to attach the outrigger to a fence or other structure, the first spring adjacent the first base, and a second base to attach the outrigger to a fence or other structure, the second spring adjacent the second base, the outrigger adapted to be attached to the fence or other structure with the first and second bases spaced vertically apart.

In some embodiments, the device comprises a first elongate member extending between the first spring and the holder, and a second elongate member extending between the second spring and the holder, to space the conductor away from the fence or other structure.

In some embodiments, the first and second elongate members are integrally formed, the outrigger comprising an elongate member extending between the first and second springs, and wherein the holder is located intermediate the elongate member between the first and second springs to space the conductor away from the fence.

In some embodiments, the holder is a loop integrally formed with the first and/or second elongate members.

In some embodiments, the first and second elongate members and the holder are integrally formed from the length of wire.

In some embodiments, the outrigger comprises an insulation material covering the holder and the first and second elongate members for substantially a full length of the first and second elongate members.

In some embodiments, the first spring and the first elongate member are integrally formed from a first length of wire and the second spring and the second elongate member are integrally formed from a second length of wire, and the holder comprises a first loop integrally formed with or attached to the first elongate member and a second loop integrally formed with or attached to the second elongate member, in use the first and second loops overlapped to receive the electrified conductor

In a preferred embodiment the device is an outrigger for supporting an electrified elongate conductor from a fence or other structure, the outrigger comprising: at least one spring adjacent (e.g. attached to or formed with) the base, a holder for supporting the conductor, and at least one elongate member extending (and connected) between the spring and the holder to space the conductor laterally away from the fence or other structure, the spring and the elongate member integrally formed from a length of wire; wherein the spring(s) is/are configured to deform elastically to allow the elongate member and holder to move from an un-deflected position with the conductor supported laterally away from the fence or other structure to a deflected position towards the fence or other structure in at least a sideways direction upon application of a force lateral to the elongate member or holder, and to spring back again to the un-deflected position once the force is removed.

In some embodiments, there is a Device for Supporting an Electrified Wire wherein said first spring and said first elongate member are integrally formed from a first length of wire and said second spring and said second elongate member are integrally formed from a second length of wire, and said holder comprises a first loop integrally formed with or attached to said first elongate member and a second loop integrally formed with or attached to said second elongate member, in use said first loop and said second loop overlap to receive said electrified elongate conductor.

An advantage of the Device for Supporting an Electrified Wire when used connectively attached to fencing or other boundary structures is that it enables the containment of livestock either as an electric fence or a series of probes (elongate members) extended into the containment area to prevent livestock from rubbing, bumping, scratching, or pushing against the fencing perimeter and inhibit escape.

The invention will now be described, by way of example only, with reference to the accompanying drawings in which:

### BRIEF DESCRIPTION OF THE DRAWINGS

FIG. 1 shows a fence with an outrigger attached to each post of the fence, the outriggers supporting an electrified wire;

FIG. 2 shows the top portion of one fence post and the outrigger;

FIG. 3 shows the top portion of one fence post and the outrigger and fastener for attaching the outrigger to the fence post;

FIG. 4 shows a view on a base of the outrigger;

FIG. 5 shows the outrigger deflected to two deflected positions, an upwards deflected position and a downwards deflected position;

FIG. 6 shows the outrigger deflected to two deflected positions, to a left side deflected position and a right side deflected position;

FIG. 7 shows a fence with an outrigger attached to each post of the fence, the outriggers supporting an electrified wire;

FIG. 8 shows the top portion of one fence post and the outrigger from FIG. 7;

FIG. 9 is a side view of the fence post and outrigger from FIGS. 7 and 8;

FIG. 10 shows the top portion of the fence post and the outrigger from FIG. 9 and a fastener for attaching the outrigger to the fence post;

FIGS. 11 and 12 show front and top views of the post and outrigger from FIG. 9 deflected to two deflected positions, to a left side deflected position and a right side deflected position;

FIG. 13 shows another outrigger adjacent a top of a fence post;

FIG. 14 shows another outrigger adjacent the top of a fence post;

FIG. 15 shows another outrigger adjacent the top of a fence post;

FIG. 16 shows another outrigger adjacent the top of a fence post;

FIG. 17 shows an outrigger according to an embodiment of the present invention;

FIG. 18 is an exploded view of the outrigger of FIG. 17;

FIG. 19 shows an outrigger according to another embodiment of the present invention;

FIG. 20 is an exploded view of the outrigger of FIG. 19;

FIG. 21 shows an isolator base of the outrigger of FIG. 17 used to isolate an electrified wire from a fence post;

FIG. 22 shows a cross section of an isolating base for an outrigger as shown in FIG. 17;

FIGS. 23 and 24 show the outrigger of FIG. 17 attached to the top of a fence post;

FIG. 25 shows a device for supporting an electrified wire on a fence post;

FIG. 26 shows an outrigger according to another embodiment of the present invention.

### DETAILED DESCRIPTION

The detailed embodiments of the present invention are disclosed herein. The disclosed embodiments are merely exemplary of the invention, which may be embodied in various forms. The details disclosed herein are not to be interpreted as limiting, but merely as the basis for the claims and as a basis for teaching one skilled in the art how to make and use the invention.

References in the specification to “one embodiment,” “an embodiment,” “an example embodiment,” etcetera, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

Throughout this specification, the word “comprise”, or variations thereof such as “comprises” or “comprising”, will be understood to imply the inclusion of a stated element, integer or step, or group of elements integers or steps, but not the exclusion of any other element, integer or step, or group of elements, integers or steps.

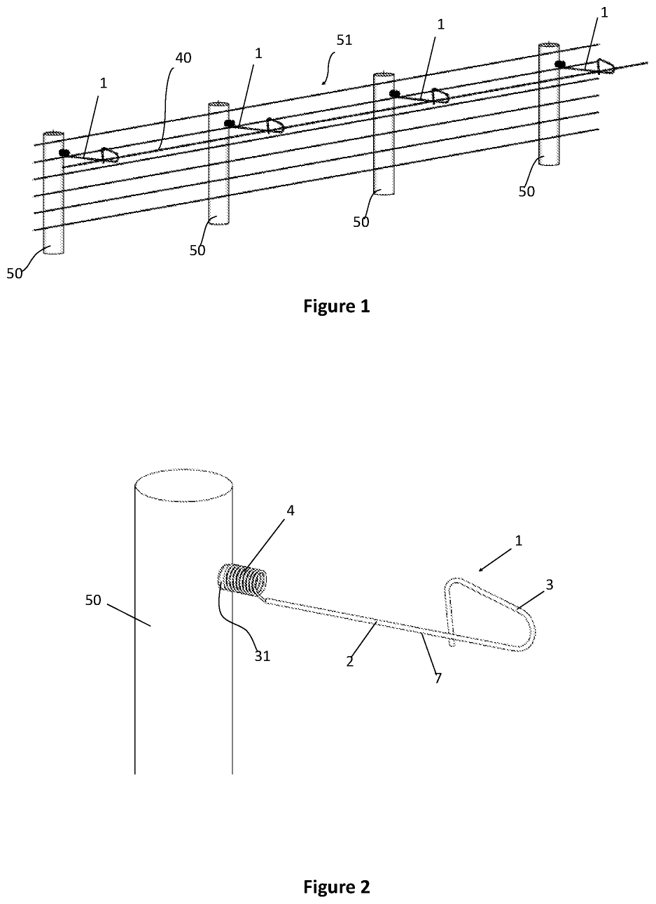

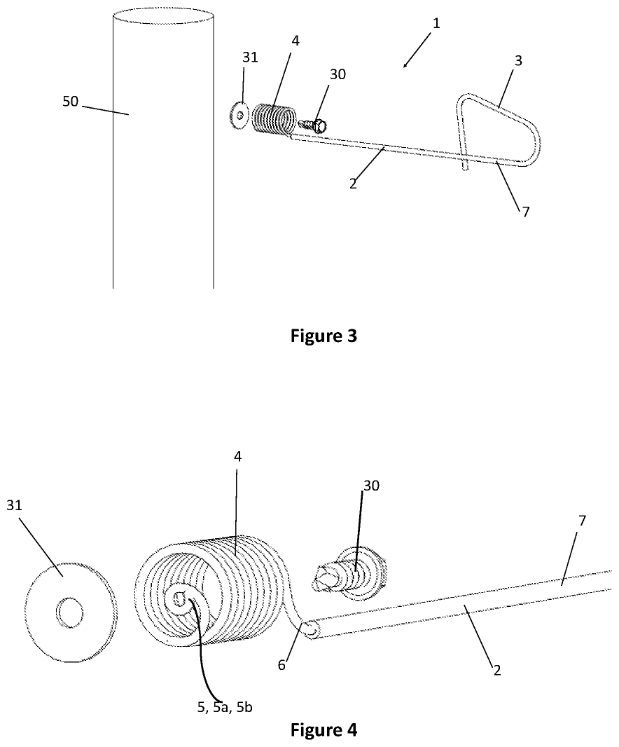

In an embodiment, there is a device for supporting an electrified wire on a fence or other structure of the present invention is described with reference to FIGS. 1 to 6. The illustrated device 1 is an outrigger for holding the wire 40 outwardly a lateral distance from the fence. The outrigger 1 has a base 5 (FIG. 4) to attach the outrigger 1 to a fence post, a resilient element 4 adjacent the base 5, and an elongate member or arm 2 extending from the resilient member, for spacing the wire or elongate electrical conductor 40 away from the fence.

A proximal end of the elongate member is attached to or formed with the resilient element. A holder 3 is provided at a distal end of the elongate member 2 for supporting the electrical conductor 40. In some embodiments, the outrigger includes an insulating material provided to the holder to insulate the electrical conductor from the fence. In the illustrated embodiment the holder is formed as an eye or loop to receive and retain the electrical conductor 40, such as an electrified wire. However alternative holder configurations are possible, such as a clip arrangement to which a wire 40 can be clipped and retained.

In the illustrated embodiment, the eye or loop 3 comprises an insulating covering material 7 and in the illustrated embodiment the insulating material covers the eye 3 and substantially a full length of the elongate member 2, e.g. from the distal end of the elongate member to the proximal end of the elongate member. The insulation material 7 may comprise a UV stabilizer to prolong the life of the outrigger.

In FIG. 1, a fence 51 is shown with an outrigger 1 attached to each post 50 of the fence. The elongate member 2 is of a sufficient length to locate the wire 40 laterally from a fence or other structure to prevent an animal impacting and damaging the fence. The outrigger may space the wire 150 mm to 400 mm or more from the fence.

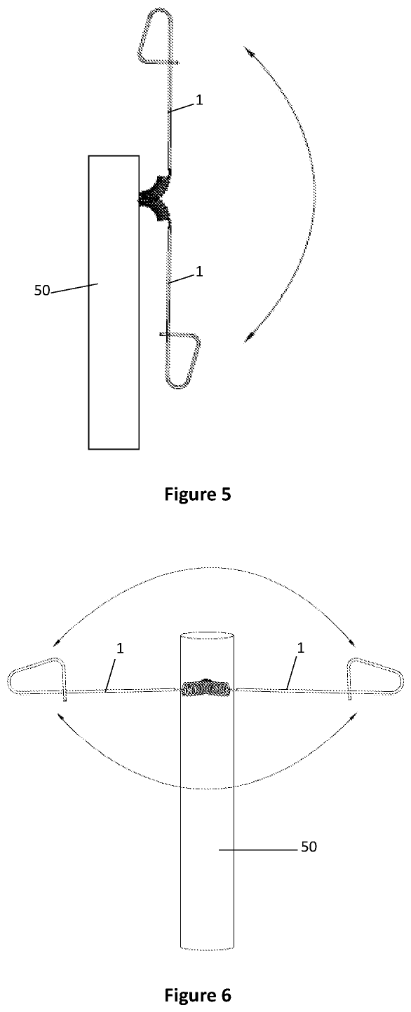

According to the present invention, the resilient element 4 located between the base 5 and the elongate member 2 is configured to deform elastically, to allow the elongate member 2 and the holder 3 to move from an un-deflected position with the conductor supported away from the fence, as shown in FIGS. 1 and 2, to a deflected position towards the fence, as shown in FIGS. 5 and 6. The resilient member may allow the elongate member to defect from being positioned substantially perpendicular to the fence or other structure when in the un-deflected position, to being positioned substantially parallel to the fence or other structure when in the un-deflected position.

FIG. 5 shows two deflected positions, with the resilient element deflected to position the elongate member 2 and holder 3 in an upwards position, and with the resilient element deflected to position the elongate member 2 and holder 3 in a downwards position. FIG. 6 also shows the outrigger deflected to two deflected positions, with the resilient element deflected to position the elongate member 2 and holder 3 in a left position and in a right position. For the illustrated embodiment, the resilient member 4 allows the elongate member 2 and holder 3 to be articulated from the post 360 degrees about the base 5 with respect to an end view on the outrigger when in the un-deflected position, i.e. the view shown in FIG. 6.

The resilient element 4 thus allows the outrigger 1 to be elastically deflected upon application of a force lateral to the elongate member or holder. This is particularly beneficial to prevent damage to the outrigger 1 when knocked or impacted by an animal or any other object, such as a vehicle passing by the fence 51. Once the force is removed from the outrigger, the resilient member springs back to the un-deflected position, to again maintain the wire at a lateral spacing from the fence. By avoiding damage to the outrigger, a possible short circuit of the electrified wire circuit is avoided.

The resilient element provides substantially more resiliency in a lateral direction than the elongate member. The elongate member may be relatively stiff compared to the resilient element. When a force is applied to the elongate member or holder, the elongate member may flex slightly however substantially all of the deflection of the elongate member (and holder) from the undeflected position shown in FIG. 2 to the deflected positions shown in FIGS. 5 and 6 is provided by the resilient element.

As described above, in some embodiment, the insulating material 7 covers the elongate member. This reduces the possibility of an electrical short circuit when the outrigger is deflected to the deflected position towards the fence. Even when the outrigger is deflected right back towards the fence such that the elongate member 2 may contact a non-electrified and grounded wire or other portion of the fence or other structure, the insulation 7 on the elongate member 2 prevents a short circuit.

In preferred embodiments of the invention, the resilient element 4 is a spring. In the illustrated embodiments the spring is a coil spring. The spring allows the elongate member 2 to be deflected in lateral directions with respect to a longitudinal axis of the elongate member. The coil spring 4 may be formed to be closed between coils, so that the spring does not compress when an end load is applied to the outrigger. Alternatively, the spring may be formed to have some open space between coils of the spring to take some compression with an end load applied to the outrigger.

In the illustrated embodiment the coil spring has 9 to 10 coils (turns), however more or less turns may be provided. The spring is formed from a high tensile wire with a diameter of about 3 mm and minimum breaking load of about 800 kgf. The coil spring has a spring diameter of about 20 mm.

In a preferred form of the invention, the resilient element 4 and the elongate member 2 are integrally formed. In a most preferred form, the resilient element and the elongate member are integrally formed from a length of wire. For example, the resilient element and the elongate member are integrally formed from a continuous length of high tensile fencing wire. High tensile fencing wire is readily available and provides a low-cost material for forming the outrigger, and in particular forming the resilient element and elongate member together. Furthermore, where the holder 3 is a loop, the holder 3 and the elongate member 2 can also be integrally formed from the length of wire. However, other materials may be used to form the outrigger.

High tensile fencing wire preferably has a minimum breaking load of at least 300 kgf, and 35 preferably at least 500 kgf, and most preferably at least 700 kgf. In a preferred embodiment the outrigger is formed from a length of 3.15 mm diameter high tensile fencing wire with a minimum braking load of more than 800 kgf, however larger or smaller diameter wire may be used.

In a further preferred embodiment, and as illustrated in FIGS. 1 to 6 and in particular as shown in FIG. 4, the base 5 is integrally formed with the resilient element 4. Where the resilient member is a coil spring, the coil spring 4 and base 5 may be integrally formed from a length of wire. The base 5 can be formed by a loop or single coil of the wire, the loop having a diameter less than a diameter of the coil spring 4. To attach the outrigger to the post or other structure, a fastener 30 is provided through the loop 5 to penetrate the fence post 50 or structure and with a head of the fastener 30 bearing against the loop 5 to secure the outrigger to the post or structure. The loop may be formed outwards of the spring 4 or may be formed coaxial with the spring as illustrated. When coaxial with the spring, the fastener is applied through the centre of the spring 4 to extend through the loop 5 and into the post or structure. A washer 31 may be provided between the base and the post to spread load applied by the fastener to the base.

In some embodiments, and as shown in FIG. 15, the loop 3 is elongated, with a major dimension ‘x’ oriented horizontally and a minor dimension ‘y’ orthogonal to the major dimension oriented vertically. The major dimension is aligned with the elongate member 2. The loop 3 elongated in the horizontal direction provides for movement of the wire 40 in the horizontal direction to allow the hotwire to move with the elongate member without bending the loop 3 out of shape or gripping on the loop 3 which may prevent the elongate member from moving further if pushed. The loop length along the elongate member is important for horizontal movement but not for vertical movement. Thus, preferably the vertical dimension of the loop is smaller than the horizontal dimension. For example, the major dimension or length of the loop in the horizontal direction is about 50 mm to 100 mm and the minor dimension or height of the loop in the vertical direction is about 20 mm to 40 mm. Where an alternative holder is used, such as a clip, the holder preferably is able to swivel or slide or otherwise move a small distance in the horizontal direction relative to the elongate member.

To make the outrigger 1 from a length of wire, the base 5 and the coil spring 4 may be wound at one end of the length of wire, and the holder loop 3 is made at the other end of the length of wire. When winding the coil spring the spring may be formed with a longitudinal axis of the spring orthogonal to the elongate member and the longitudinal axis of the wire. The wire is then bent so that the elongate member extends longitudinally with respect to the coil spring. Alternatively, the longitudinal axis of the spring may be orthogonal to the elongate member for mounting the outrigger to a side face of a post, rather than to a front face of the post. The insulation 7 may be provided to the wire before or after forming the loop and the base and spring, however, in a preferred method of manufacture where an insulator is provided to the holder, the insulation 7 is provided to the wire prior to winding the base 5 and spring 4 and forming the loop 3. The insulation may be heated to assist with bending when forming the loop holder 3. Heating the insulation can allow for a tighter loop to be made compared to if the insulation is unheated, for example as shown in FIG. 15. A smaller loop 3 may be used to better secure the live wire 40. A suitable material for the insulation is low density polyethylene tubing.

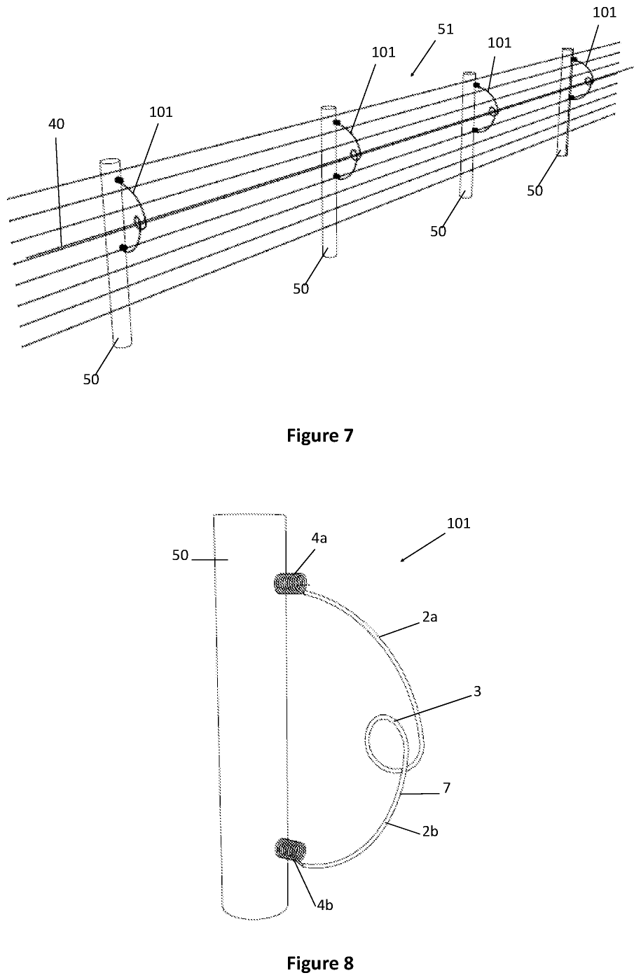

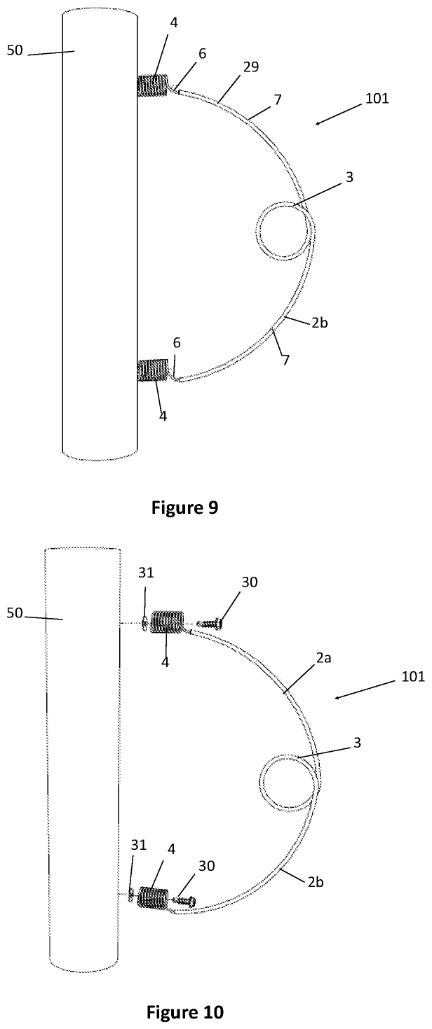

An outrigger 101 according to another embodiment of the present invention is described with reference to FIGS. 7 to 12. The same reference numerals appearing in FIGS. 1 to 6 are used to designate equivalent components in FIGS. 7 to 12.

The illustrated outrigger 101 has two resilient elements and corresponding bases for attaching the outrigger to a post or other structure. The outrigger has a first base 5a (e.g. like that shown in FIG. 4) and a second base 5b to attach the outrigger to a fence or other structure. A first elongate member or arm 2a and a second elongate member or arm 2b space the conductor away from the fence. A first resilient element 4a is located between the first base 5 and a proximal end of the first elongate member 4a, and a second resilient element 4b is located between the second base and a proximal end of the second elongate member. A holder is located at distal ends of the first and second elongate members and in the illustrated embodiment joins the first and second elongate members together. In use the outrigger is attached to a fence or other structure with the first and second bases and resilient elements vertically spaced apart on the post or other structure, and with the first and second elongate members extending between the first and second resilient elements and the holder to position the conductor 40 laterally away from the fence. The springs may be vertically spaced apart by at least 50 mm, or at least 100 mm, or at least 150 mm, or at least 200 mm (e.g. distance between spring centers).

In the illustrated embodiment, when mounted to the post, the first and second elongate members are curved so that together they form a substantially C-shaped member extending between the resilient elements, with the holder located at an intermediate position along the C-shaped member. The elongate members may be aligned, e.g. in a straight line, prior to attaching the outrigger to the post, and may be bent (elastically or plastically) into a curved or bent shape when fixing the outrigger to the post. In use the outrigger may be shaped other than C-shaped, for example the first and second elongate members may comprise a right angle bend. FIG. 16 illustrates a further possible shape wherein the holder 3 is aligned with the first elongate member 2a and/or first resilient element 4a located uppermost in use. The second elongate member 2b extends in a straight length from the holder 3 to the second resilient element 4b at an angle to the uppermost elongate member, to act as a strut to support the holder and uppermost elongate member to resist bending and deformation in the vertical direction. Alternatively, the outrigger may be arranged upside-down compared to the illustrated orientation, with the holder 3 aligned with the elongate member 2b located lowermost in use, with the uppermost elongate member 2a acting as a strut as described above.

The components of the outrigger 101 such as the resilient elements are as described with reference to FIGS. 1 to 6 and so are not described again with reference to the embodiment of FIGS. 7 to 12. For example, in the illustrated the resilient elements are first and second coil springs. Insulation may be provided to the holder and/or substantially the full length of the first and second elongate members.

In the illustrated embodiment, the first resilient element 4a, the first elongate member 2a, the holder 3, the second elongate member 2b and the second resilient element 4b are integrally formed from a length of wire. As illustrated, the first base 5a, the first resilient element 4a, the first elongate member 2a, the holder 3, the second elongate member 2b, the second resilient element 4b and the second base 5a are integrally formed from the length of wire. Each of the first and second base are as described above with reference to FIG. 4. Alternatively, the first resilient element and elongate member may be made from a first single length of wire, and the second resilient element and elongate member may be made from a second single length of wire. The holder may be attached to the first and second elongate members, joining the first and second elongate members together. For example, a plastic holder may be over-moulded to ends of the first and second elongate members. Alternatively, the holder, e.g. loop 3, may be integrally formed with the first elongate member from the first single length of wire, and the second elongate member attached to the first elongate member, e.g. by welding, or the holder, e.g. loop 3, may be integrally formed with the second elongate member from the second single length of wire, and the first elongate member attached to the second elongate member, e.g. by welding.

The first and second elongate members may be described as an elongate member extending between the first and second spring elements, with the holder located at an intermediate position along the elongate member. For example, in the illustrated embodiment, the first and second elongate members and holder may be described as an elongate member with an intermediate loop forming the holder. In another embodiment, the outrigger may comprise an elongate member extending between the first and second resilient elements, with a holder for supporting the electrified wire 40 attached to an intermediate portion of the elongate member.

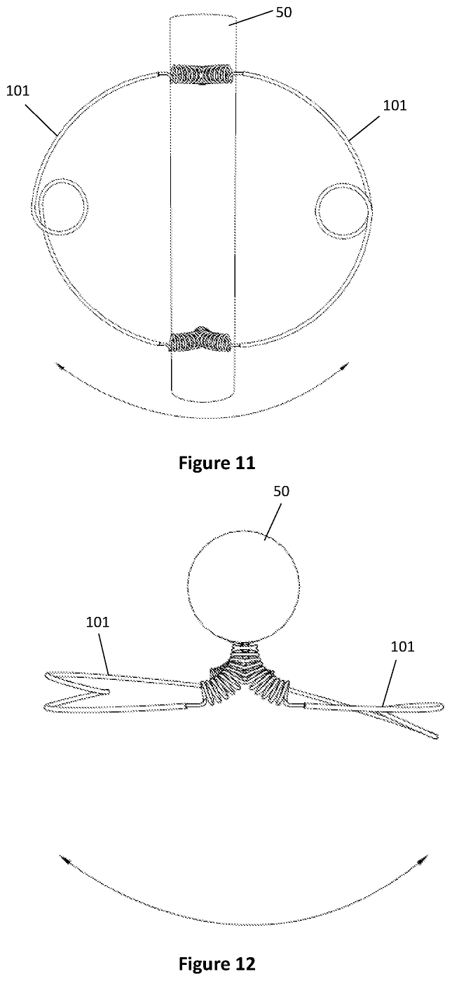

The outrigger described above with reference to FIGS. 7 to 12 is particularly useful for supporting an electrified wire over hilly country. The wire 40 places a vertical load on the outrigger as a fence and associated live wire travels up and down over hills. The outrigger 101 with two vertically spaced apart resilient members resists a downwards or upwards force applied by the wire 40, largely preventing upwards and downwards deflection of the elongate member(s) and holder, while still providing an outrigger than allows for deflection in sideways directions as shown in FIGS. 11 and 12. The spring elements 4a, 4b may be vertically aligned and spaced apart, as shown in FIGS. 11 and 12.

When a post is located in a gully and the wire runs upwards either side of the post, the wire applies an upwards force to the outrigger 101, and the upper coil spring 4a is placed in compression and the bottom coil spring 4b is placed in tension. When a post is located on a ridge of a hill and the wire runs downwards either side of the post, the wire applies a downwards force to the outrigger 101, and the upper coil spring 4a is placed in tension and the bottom coil spring is placed in compression 4b. The opposed compression and tension of the springs resists the upwards or downwards load applied by the wire, maintaining the outrigger and the holder of the outrigger in an ‘un-deflected position’ with the wire maintained outwards from the fence.

A method for making the outrigger 101 from a single length of wire is the same as for the method for making the outrigger 1 described above. However, a base and coil spring is wound at each end of the length of wire, and a loop 3 is formed in the wire extending between the two coil springs. In embodiments comprising insulation on the holder, preferably the insulation material is provided to the wire before forming the springs 4a, 4b and/or loop 3. The outrigger may be provided with the elongate member 2a, 2b or wire extending between the first and second resilient members in a straight length, without loop 3 formed, and the user such as a farmer may form the loop 3 and bend members 2a, 2b when attaching the outrigger to a fence or other structure, however, due to the stiffness of the material forming the elongate member 2a, 2b the preferred approach is to manufacture and provide the outrigger to the end user already formed to be ready for use.

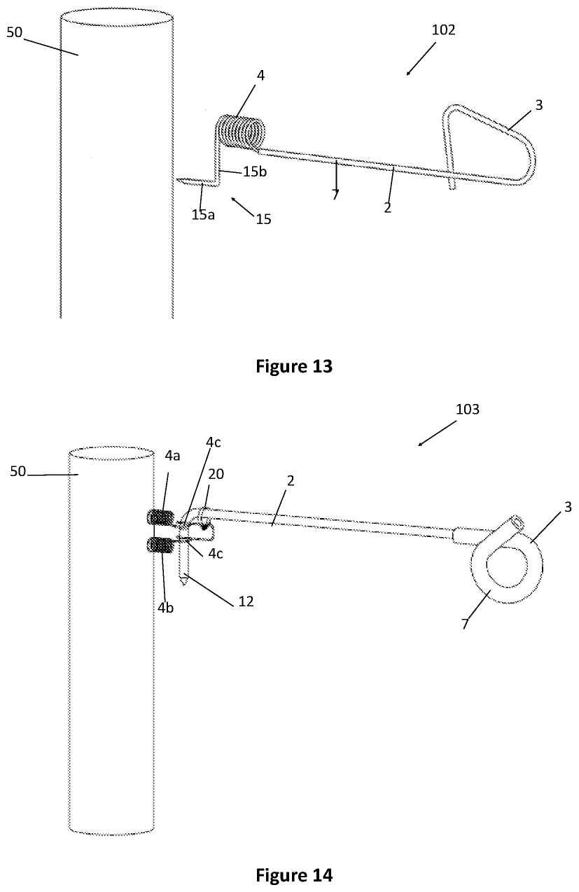

Alternative means may be provided for attaching the outrigger to a post or other structure. As shown in FIG. 13, an outrigger 102 according to the present invention may include a base 15 comprising a spike 15a for penetrating the post or structure, to attach the outrigger to the post 35 or other structure. In the illustrated embodiment the spike is integrally formed with the resilient element from a continuous length of wire. The wire extends laterally from the resilient element 4, and the spike 15a is bent at a right angle to the lateral portion 15b of the wire, to present an end of the spike that can be impacted with a hammer to drive the spike into the post or structure. The user may then further secure the outrigger by applying a fence staple about the lateral portion 15b.

The illustrated embodiments are particularly suitable for attaching the outrigger to a timber post.

In some embodiments, the outrigger may have a base adapted to attach the outrigger to other posts or structures. For example, the base may be configured to clip or otherwise attach the outrigger to a wire of a fence. The base may comprise a length of wire extending from a base of the spring, the length of wire to be wrapped or twisted around a wire of a fence by a user or installer such as a farmer. Other arrangements are possible, for example the base comprising a clip or other means to attach the outrigger to a metal post such as a steel Y section Waratah® post.

Furthermore, the outrigger may be provided with a base common to and supporting both resilient elements. For example, an outrigger according to the present invention may comprise a base plate, with two resilient elements spaced apart and mounted to the base plate. The base plate may be provided with one or more fastener holes to receive one or more fasteners to attach the base plate to a fence or other structure.

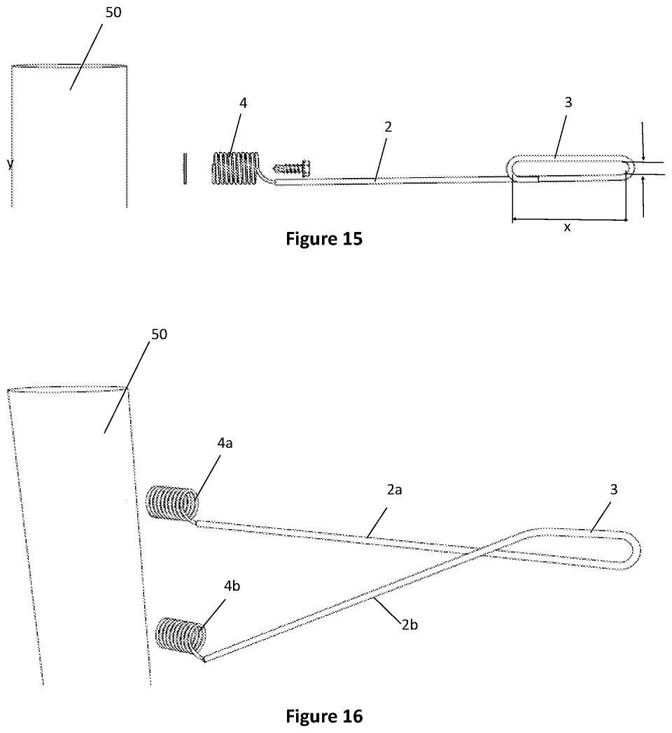

FIG. 14 illustrates a further alternative embodiment. The outrigger 103 comprises a first resilient element 4a and a second resilient element 4b, and an elongate member 2 extending between the first and second resilient elements and a holder 3. In the illustrated embodiment the elongate member is assembled to the resilient elements 4a and 4b. The first and second resilient elements are integrally formed by a length of wire. Each of the resilient elements is provided with a base to be attached to the post. Alternatively, and as described above, the first and second resilient elements may be mounted to a common base. The wire is formed with two vertically spaced loops 4c to receive a vertical member 12 extending from the elongate member 2 of the outrigger, to attach the elongate member to the resilient element. The loops 4c may be formed with an internal diameter smaller than an outside diameter of the member 12, such that the loops are deformed elastically to receive and clamp the member 12. Additional securing means may be provided to attach the elongate member to the resilient element, for example a band member 20 that loops around the elongate member 2 and a portion of the wire forming the resilient elements.

Coil spring resilient elements have been provided by way of example. Other types or configurations of resilient elements may be provided. For example, the resilient element of an outrigger according to the present invention may be in the form of an elastomeric member or block or other form of spring, such as a ‘leaf spring’ that allows elastic bending in a horizontal direction.

The holder of the illustrated embodiments is a loop for retaining the wire. Other holders are possible, for example clips or other arrangements to which the elongate conductor may be attached.

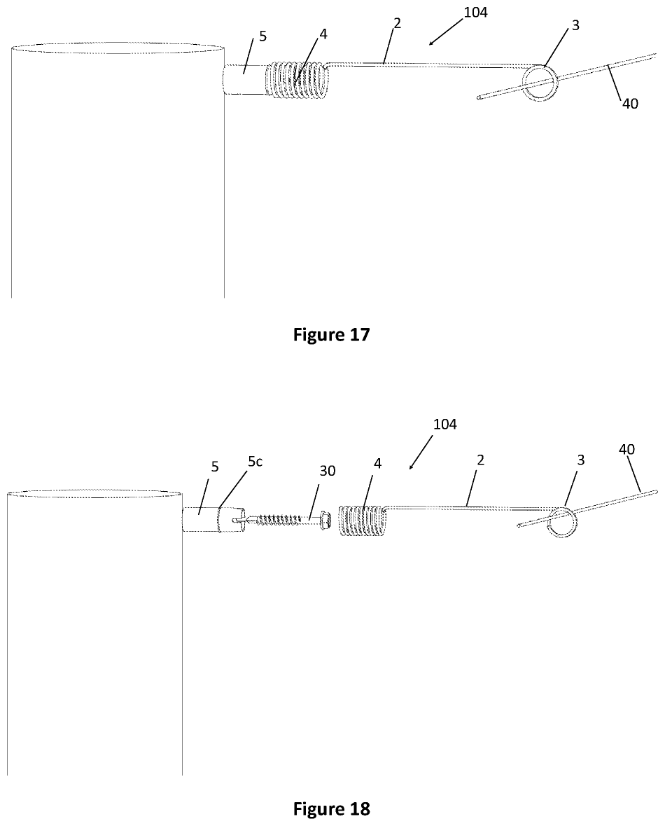

In some embodiments, the resilient member(s) may be attached to the base. FIGS. 17 and 18 illustrate such an outrigger 104 according to an embodiment where the resilient member is assembled to the base. The base 5 is fixed to a post or other support structure, for example by a fastener 30. The base may be tubular with a wall at one end provided with a fastener hole through the wall to secure the base to the post/structure. The hole may be provided with a taper or countersink to assist with locating the hole with the tip of the fastener. The resilient member 4 together with elongate member 2 and holder 3 may be attached to the base after the base has been fixed to the post, allowing for easy installation. In the illustrated embodiment, the base comprises a substantially cylindrical portion to engage an inner diameter of the coil spring resilient member 4. The spring may be wound onto the cylindrical portion to attach the spring to the base and/or the spring may be pushed onto the cylindrical portion to attach the spring to the base. A tight fit may be provided between the spring and the base, such that the resilient element is held to the base by friction. The base may comprise a marker or stop 5c to indicate to an installer when the spring 4 has been fully assembled to the base 5.

In some embodiments, the base may comprise an insulating material or may be formed from an insulating material. For example, in the embodiment of FIGS. 17 and 18, the base may be formed from a plastics insulating material, for example polyethylene or other suitable electrically non-conductive material. In such an embodiment, the resilient member 4, elongate member 2 and the holder 3 are electrically live together with the live conductor 40 supported by the outrigger 104. In such an embodiment, care must be taken to ensure the fastener 30 does not contact a live portion of the outrigger. To assist with correct installation, the base comprises a mark or stop as described above. The mark or stop ensures the spring is not engaged to far onto the base. In some embodiments, the insulating base may be permanently fixed to the spring, for example may be integrally formed with the spring by being plastic over-moulded to the spring. The plastic material of the insulator may comprise a UV stabilizer.

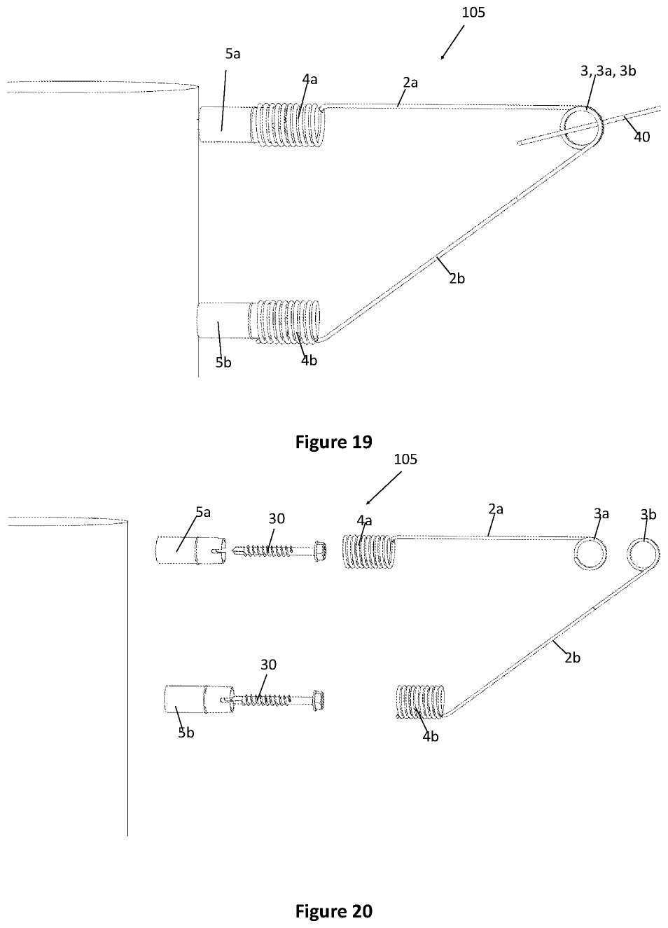

FIGS. 19 and 20 illustrate an embodiment 105 comprising two resilient members, like that described above with reference to FIGS. 7 to 12, but comprising separate bases 5a, 5b to which the resilient members are attached, as described above with reference to FIGS. 17 and 18. As best shown in FIG. 20, the first resilient member 4a, first elongate member 2a and a first holder 3a are integrally formed from a first length of wire, and the second resilient member 4b, first elongate member 2b and a first holder 3b are integrally formed from a (separate) second length of wire. In use, and as shown in FIG. 19, the first and second holders (loops) are aligned/overlapped to receive and retain the hot wire 40. The second elongate member 2b is longer than the first elongate member so that the second elongate member may be arranged at an angle to the first elongate member to act as a strut, as described above with reference to FIG. 16. In FIGS. 19 and 20, the bases 5a and 5b are separate, however a common base may be provided to which both the first and second resilient elements are attached, to assist with a correct relative positioning of the first and second resilient members to the fence post.

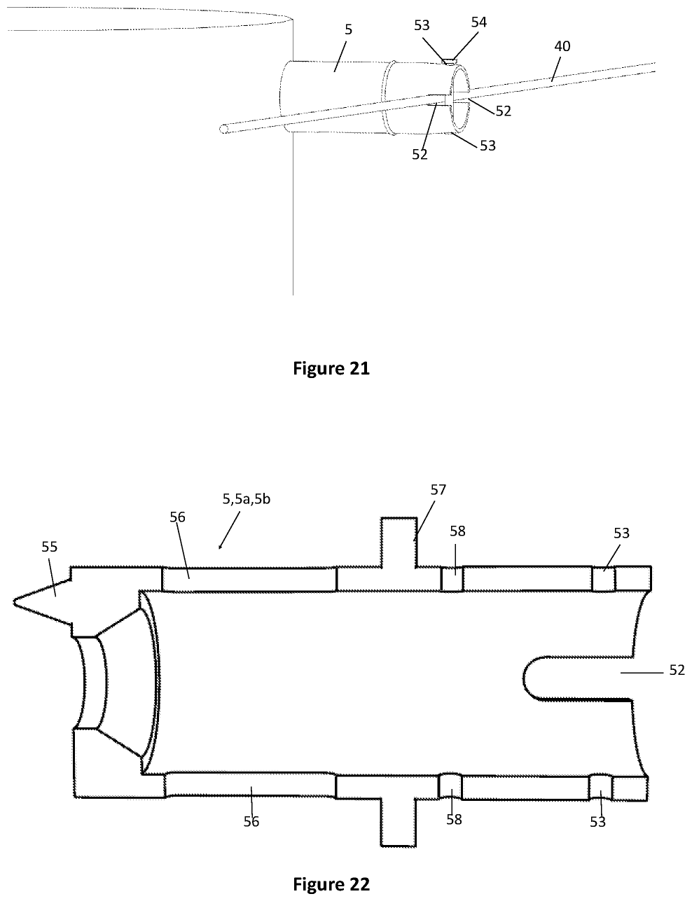

The base 5, 5a, 5b shown in FIGS. 17 to 20 may be used as an isolator for holding an electrified wire to a fence or other structure, as shown in FIG. 21. The base or isolator 5 has a pair of slots 52 diametrically opposed for receiving the wire 40. A pin 54 may be provided to secure the wire to the isolator. The pin is received in two diametrically opposed holes 53.

With reference to FIG. 22, the base 5, may have a projection or spike 55 at an end of the base to engage the post or structure. The spike penetrates the surface of the post or structure to help hold the base against turning on the post when fixing the base to the post or structure with the fastener. There may be one, two or more projections or spikes. The isolator/base may also have at least one slot 56 to allow water to drain from an inside of the base/isolator. In the illustrated embodiment the slot is parallel to a longitudinal axis of the base and there are two slots, diametrically opposed.

In FIG. 22 the base comprises a flange 57 projecting from an outer surface. One or more flanges may be provided, to increase the area of the surface for when the insulator is used in a very high voltage system. The flange (collar) will also break any water layers that forms during rain. The flange is perpendicular to a longitudinal axis of the cylindrical portion but may extend at an angle and can be otherwise shaped, for example a triangular shape. The flange 57 may present a stop to set a maximum location of the spring on the base, and/or may provide a barrier to arcing between the live portion of the outrigger and the post/structure.

In FIG. 22 the base comprises two diametrically opposed holes 58 for receiving a pin to secure the coil spring to the base. The spring may be wound with a gap between two adjacent turns of the spring. The spring is assembled to the base with the holes aligned with the gap between adjacent turns, and a pin provided through the holes and gap to secure the spring to the isolator.

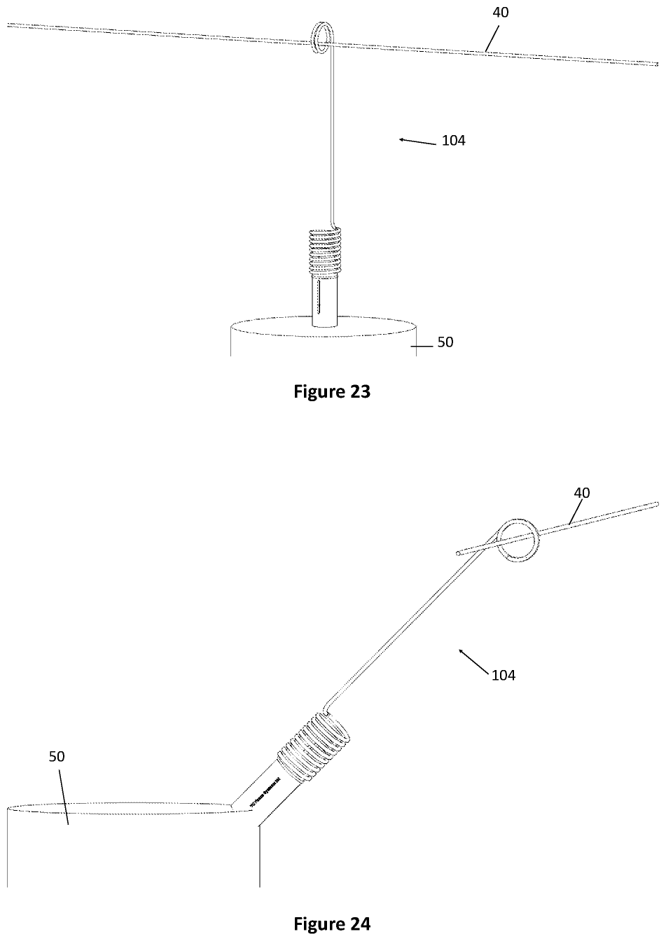

The outrigger may be attached to a side of a post or structure, or to the top of a post, to extend vertically as shown in FIG. 23, or at an angle to vertical as shown in FIG. 24. Such installations may be preferable for some animals, such as deer and horses.

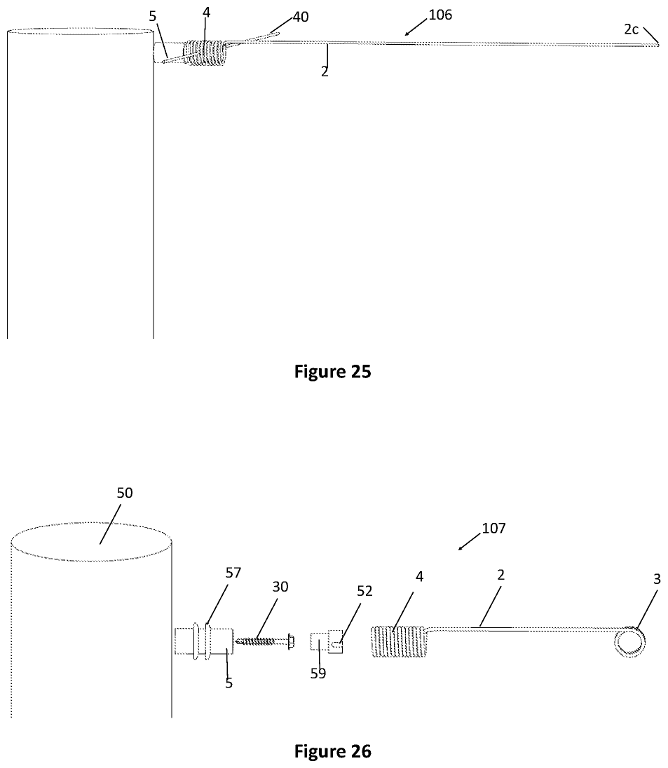

FIG. 25 illustrates an embodiment of a device 106 for holding a hot wire 40 to a fence or other structure without a wire holder at a distal end 2c of the elongate member. The hot wire 40 is held by the insulating base 5, for example as described above with reference to FIG. 21. The spring 4 is connected to the base 5 so that the hot wire 40 is in contact with the spring 4 and/or elongate member 2 so that the elongate member 2 is live together with the live wire 40. For example, to secure the wire 40 to the resilient element 4, the spring is wound to have a gap between adjacent turns of the spring. The hot wire 40 is placed in the gap between the adjacent turns, and the spring 4 is then pushed onto the cylindrical portion of the base 5 so that the hot wire is received in the slots (52 FIG. 21) in the end of the cylindrical portion, additionally securing the wire to the base. The embodiment of FIG. 25 is particularly suited for deer which can have a tendency to get their antlers tangled in a wire 40 held outwards from a fence. The electrified elongate member can make contact with a deer before the deer contacts the wire held by the insulator near to the fence, reducing damage to the fence.

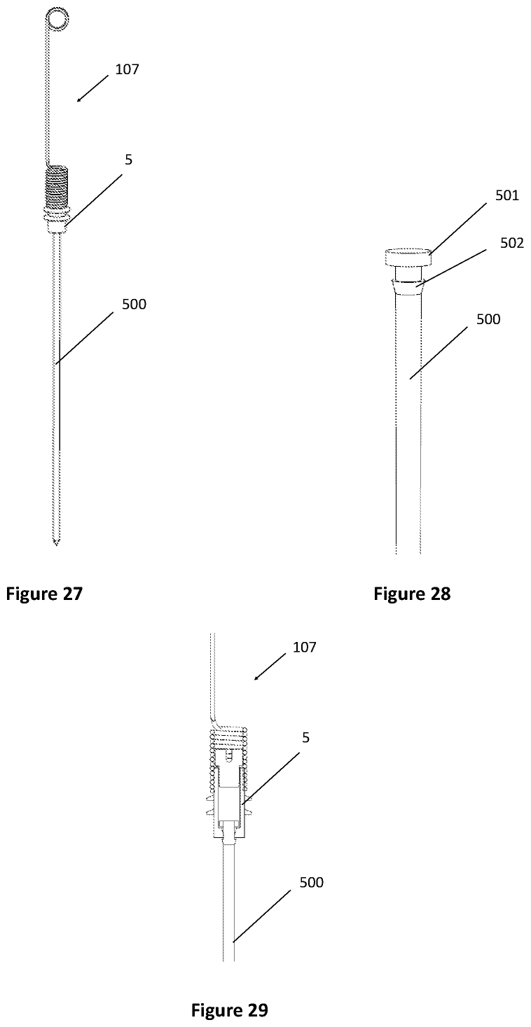

FIG. 26 shows another embodiment similar to that shown in FIG. 25. The base 5 includes two flanges 57 to increase the insulating area/distance between the live parts and ground (the post). Additionally, the base 5 includes a cap 59 to cover the screw. The cap covers the fastener to prevent or reduce water reaching the fastener and the inside of the insulating base 5. Preferably the cap covers over an end of the base to close an inside of the base in which the fastener is received. The cap is provided with a slot 52 to receive the electrified wire, as described above with reference to the embodiment of FIG. 22. The cap 59 may press into an internal bore of the body of the base 5 by friction fit or may have a positive engagement so that the cap clips in to the base.

The present invention has benefits including reducing likelihood of damage to a fence and electrified wire system, even when the electrified wire is turned off. The devices are preferably made from high tensile wire or spring steel, which is particularly robust yet low cost, with a long life span. Where embodiments comprise a separate insulating base, the base may be replaced periodically, while the rest of the device comprising the resilient element, elongate member and holder can be reused. In embodiments comprising a single base and resilient member, the device may be attached to a post with a single screw, which provides for a fast and easy installation.

Aspects of the present invention have been described by way of example only and it should be appreciated that modifications and additions may be made thereto without departing from the scope thereof as defined in the appended claims.

The invention may also be said broadly to consist in the parts, elements and features referred to or indicated in the specification of the application, individually or collectively, in any or all combinations of two or more of said parts, elements or features.

The invention has been described by way of examples only. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the claims.

Although the invention has been explained in relation to various embodiments, it is to be understood that many other possible modifications and variations can be made without departing from the spirit and scope of the invention.

1. A device for supporting an electrified elongate conductor on a fence or other structure, the device comprising an insulating base for attaching said device to a fence or other structure, a spring connectively attached to said base, and an elongate member connectively attached to said spring positioned to extend away from said fence or other structure, wherein said spring is configured to deform elastically to allow the elongate member to move from an un-deflected position with a distal end laterally away from the fence or other structure to a deflected position towards the fence or other structure in at least a sideways direction upon application of a force lateral to the elongate member, and to spring back again to the un-deflected position once the force is removed.

2. A device as claimed in claim 1, wherein the device is an outrigger for holding said electrified elongate conductor away from said fence, wherein said outrigger comprises a holder for supporting said electrified elongate conductor, said elongate member extending between said spring and said holder to space said electrified elongate conductor laterally away from said fence or other structure.

3. The device as claimed in claim 1, wherein said spring is a coil spring, and wherein the elongate member extends longitudinally with respect to a longitudinal axis of the coil spring.

4. The device as in claim 1, wherein said electrified elongate conductor is a high tensile fencing wire.

5. The device as in claim 1, wherein said insulating base is adapted to hold said electrified elongate conductor in electrical contact with said spring and/or said elongate member to electrify said spring and/or said elongate member in use.

6. The device as in claim 2, wherein said insulating base is adapted to hold said electrified elongate conductor in electrical contact with said spring and/or said elongate member to electrify said spring and/or said elongate member in use.

7. The device as in claim 2, wherein said outrigger comprises a first spring and a second spring, and at least one elongate member extending between said first spring and said second spring and said holder, wherein said outrigger is adapted to be attached to said fence or other structure with the first and second springs spaced vertically apart to resist deflection of the elongate member in a vertical direction.

8. The device as claimed in claim 7, wherein the outrigger comprises a first base to attach the outrigger to a fence or other structure, said first spring adjacent a first base, and a second base to attach the outrigger to said fence or other structure, said second spring adjacent a second base, wherein the outrigger is adapted to be attached to the fence or other structure with said first base and second base spaced vertically apart.

9. The device as claimed in claim 7, wherein the outrigger comprises a first elongate member extending between said first spring and said holder and a second elongate member extending between said second spring and said holder to space said conductor away from said fence or other structure.

10. The device as claimed in claim 9, wherein said first and second elongate members are integrally formed, said outrigger comprising an elongate member extending between said first spring and said second spring, and wherein said holder is located intermediate the elongate member between said first spring and said second spring to space said electrified elongate conductor away from the fence.

11. The device as claimed in claim 9, wherein said holder is a loop integrally formed with said first elongate member and/or said second elongate member.

12. The device as claimed in claim 9, wherein said first elongate member and said second elongate member and said holder are integrally formed from a length of wire.

13. The device as claimed in claim 9, wherein said first spring and said first elongate member are integrally formed from a first length of wire and said second spring and said second elongate member are integrally formed from a second length of wire, and said holder comprises a first loop integrally formed with or attached to said first elongate member and a second loop integrally formed with or attached to said second elongate member, in use said first loop and said second loop overlap to receive said electrified elongate conductor.
